(19) United States
(12) Patent Application Publication
(10) Pub. No.: US 2014/0154769 A1
(43) Pub. Date: Jun. 5, 2014

(54) OPTICAL FILTER, PRODUCTION SYSTEM USING THE OPTICAL FILTER, AND METHOD OF USING THE OPTICAL FILTER

(71) Applicant: Wave Tech, LLC, Cincinnati, OH (US)

(72) Inventors: Matteo del Ninno, Cincinnati, OH (US); Jacob A. Bertrand, Cincinnati, OH (US)

(73) Assignee: Wave Tech, LLC, Cincinnati, OH (US)

(21) Appl. No.: 14/095,350

(22) Filed: Dec. 3, 2013

Related U.S. Application Data
(60) Provisional application No. 61/754,341, filed on Jan. 18, 2013.
(60) Provisional application No. 61/732,744, filed on Dec. 3, 2012.

(51) Int. Cl. G02B 27/10; A01G 1/00; G02B 5/20

(52) U.S. Cl. CPC G02B 27/1006; G02B 5/208; A01G 1/001
USPC 435/170; 359/359; 359/634; 435/171; 435/41; 47/1.4

(57) ABSTRACT

A production system includes a structure configured to house a light-activated biological pathway. The production system further includes an optical filter attached to the structure. The optical filter is configured to receive light, to reflect a first portion of the received light, and to transmit a second portion of the received light, wherein the first portion has a different wavelength from the second portion. The production system is further configured to position the light-activated biological pathway to receive the second portion of the receive light.

### RELATED APPLICATIONS

This application claims priority to provisional application 61/754,341 filed on Jan. 18, 2013; and provisional application 61/732,744 filed on Dec. 3, 2012, both of which are incorporated herein in their entirety.

### TECHNICAL FIELD

This description relates in general, to optical filter technology, and in particular to scalable, optical filter technology usable to increase the efficiency of photoautotrophic microalgae cultivation and other light-activated biological pathways.

### BACKGROUND

Algae, plants, and other light-activated biological pathways have an ability to transform electromagnetic energy into chemical energy in the form of high-value compounds, products, and fuels. This energy conversion takes place because photosynthetic pathways occurring in algal or other light-activated biological cells react to certain wavelengths of light.

Large scale production facilities use unfiltered natural sunlight to promote algal growth. Small scale production facilities utilize LED and laser lights as a source for providing targeted wavelengths of lights, in some approaches.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry various features may not be drawn to scale and are used for illustration purposes only. In fact, the dimensions of the various features in the drawings may be arbitrarily increased or reduced for clarity of discussion. The drawings, incorporated herein by reference, illustrate one or more embodiments and include the following:

FIG. 1 is a high level schematic diagram of an optical filter system in accordance with one or more embodiments;

FIG. 2 is a cross sectional view of an optical filter in accordance with one or more embodiments;

FIG. 3 is a cross sectional view of an optical filter having a resonance cavity in accordance with one or more embodiments;

FIG. 4 is a top view of an optical filter having a flexible substrate in accordance with one or more embodiments;

FIG. 5 is a picture of an optical filter created according to one or more embodiments;

FIG. 6 is a graph of time versus temperature in a production system according to one or more embodiments;

FIG. 7 is a graph of time versus algal concentration in a production system according to one or more embodiments; and

FIG. 8 is a graph of absorption versus wavelength for two algae species.

### DETAILED DESCRIPTION

The following disclosure provides many different embodiments, or examples, for implementing different features of the invention. Specific examples of components and arrangements are described below to simplify the present disclosure. These are examples and are not intended to be limiting.

Some embodiments of systems and methods described herein can improve energy utilization in comparison with systems which lack an optical filter. Sunlight is an abundant and free source of energy usable for photosynthesis, but sunlight also carries heat radiation, ultraviolet radiation and other high energy radiation which are damaging to biological material in some instances. In some embodiments, optical filters described herein are designed such that the optical filters do not absorb the potentially harmful radiation and thus, are able to increase a cell production or resultant by-products in a production system. In some embodiments, the optical filter reflects unwanted spectra and heat back to an ambient environment. By reflecting the heat radiation back into the ambient environment, an amount of cooling of the production system is reduced or eliminated with respect to systems which either absorb or transmit the heat radiation. By reflecting ultraviolet radiation and other high energy radiation, an amount of potentially damaging radiation entering the production system is also reduced in comparison with other systems.

Some embodiments of systems and methods described herein increase the longevity of photobioreactors. In some embodiments, an optical filter is configured to reject ultra-violet radiation, which potentially causes yellowing and degradation of polymers and decreases product lifetime. Algae cells, for example, are able to be alleviated from the harmful radiation, which can reduce the need for thick cell walls and can allow more cell energy to be spent on lipid or starch accumulation. When algae cells are exposed to ultraviolet radiation during a cell growth phase, the algae cells form thicker cells walls, in comparison with cells which are not subjected to ultraviolet radiation, in order to protect an interior of the cell from ultraviolet radiation. The formation of these thicker cell walls consumes cell energy which then is not usable for producing useful by-products. The thicker cell walls also reduce efficiency of transfer of the useful by-products out of the cell during later processes.

Some embodiments of systems and methods described herein improve performance of naturally occurring or modified micro algae, macro algae, yeast, flora, fauna, Araceae, bacteria, taxus, Nicotiana, fungi, Protista, Archaea, virus, biota, or the like. In some embodiments, micro algae includes naturally occurring or modified strains of haematococcus, spirulina, chlorella, scenedesmus, chlamydomonas or the like. In some embodiments, bacteria include naturally occurring or modified strains of Escherichia Coli, cyanobacteria or the like. In some embodiments, the system and method utilize an optical filter configured to improve cell growth performance. In some embodiments, an optical filter is used to retain plants in either the growth stage or flowering stage for a controllable period of time. In some embodiments, an optical filter is used to increase cellular production of chemicals. In some embodiments, the chemicals produced include starches, cannabinoids, ethanol, fuels, carotenoids, lipids, proteins, or other useful chemical producible by bioreactions.

Some embodiments are used to reflect growth wavelengths and transmit potentially harmful bands such as ultraviolet (UV) or infrared (IR) radiation. In some embodiments, growth wavelengths include wavelengths centered at around about 685 nanometers (nm) or a wavelength ranging from about 435 nm to 490 nm. Such filters are usable for redirecting electromagnetic radiation to light-activated biological pathways in order to maximize an amount of growth wavelengths incident on the light-activated biological pathways. Such filters are also usable to discourage the growth of unwanted organisms.

Algae are unique organisms, encompassing at least 40,000 species, and have an ability to convert energy into the form of lipids (used for producing biodiesel, jet fuel, animal feed, and nutraceuticals), starches, or direct production of ethanol, biogas, or hydrogen (H₂). For large volume production of these chemicals, microalgae strains are grown in an outdoor photoautotrophic environment and use natural sunlight as an energy source, in some embodiments. Natural sunlight is beneficial in achieving large-scale cultivation of microalgae-based biofuel or chemicals with commercial potential, in some embodiments. In some embodiments, the optical filter is used to retain plants of a taxus genus in a flowering stage or target specific light for the production of paclitaxel. In some embodiments, the optical filter is used to increase paclitaxel production in the naturally occurring or modified bacteria. In some embodiments, optical filter is used to increase yield of astaxanthin by an algae genus haematococcus.

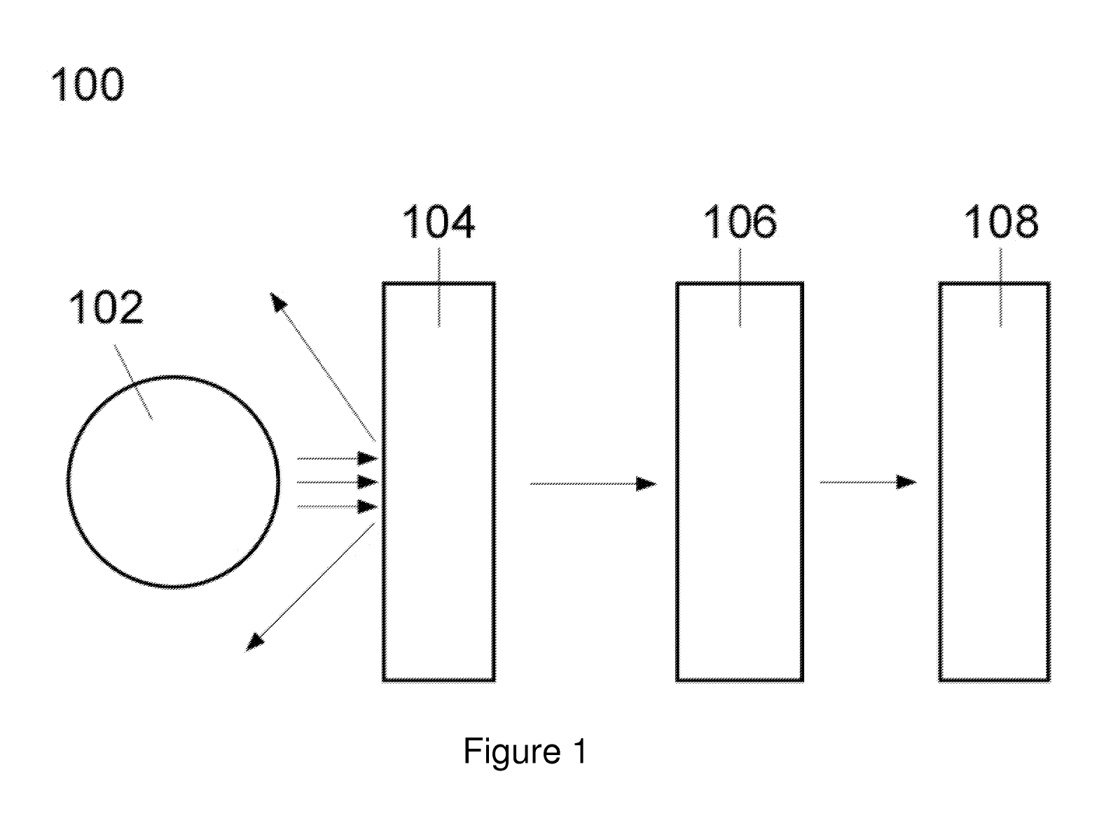

FIG. 1 is a high level schematic diagram of an optical filter system 100 in accordance with one or more embodiments. Optical filter system 100 includes a light source 102 configured to emit incident electromagnetic radiation. An optical filter 104 is configured to receive the incident electromagnetic radiation. Optical filter 104 reflects a portion of the incident electromagnetic radiation and transmits a portion of the electromagnetic radiation. A selected algae species 106 is configured to receive the transmitted portion of the electromagnetic radiation. Using the transmitted portion of the electromagnetic radiation, selected algae species 106 produces specialty products 108 which are usable as discussed above.

Light source 102 is a broadband light source configured to emit IR radiation, visible radiation, and UV radiation. In some embodiments, light source 102 is a narrow band light source configured to emit a specific wavelength or waveband. In some embodiments, light source 102 is natural sunlight. In some embodiments, light source 102 is artificial sunlight. In some embodiments, light source 102 is a light emitting diode (LED), lasers, a fluorescent light source, an incandescent light source, an arc lamp, a high pressure sodium light, or other suitable light source.

Optical filter 104 is configured to reflect the IR radiation, the UV radiation and a first portion of the visible radiation, and to transmit a second portion of the visible radiation. In some embodiments, optical filter 104 is configured to transmit the IR radiation, the UV radiation and the first portion of the visible radiation, and to reflect the second portion of visible radiation. In some embodiments, optical filter reflects at least about 90% of the UV radiation. In some embodiments, the second portion of visible radiation includes visible blue light. In some embodiments, the visible blue light has a wavelength ranging from about 430 nm to about 490 nm. In some embodiments, the second portion of visible radiation includes visible red light. In some embodiments, the visible red light includes a waveband centered around a wavelength of about 685 nm. In some embodiments, the visible red light includes a waveband ranging from about 650 nm to about 740 nm. In some embodiments, the second portion of visible radiation includes both red light and blue light. In some embodiments, a ratio of red light to blue light in the second portion of visible radiation ranges from about 1:10 to about 10:1. In some embodiments, the second portion of visible radiation includes far-red light. In some embodiments, the far-red light has a wavelength ranging from about 710 nm to about 850 nm. In some embodiments, a ratio of far-red light to red light in the second portion of visible radiation ranges from about 1:10 to about 10:1.

Selected algae species 106 receives the transmitted radiation and increases biomass or produces specialty products 108 depending on the species of the selected algae species and a wavelength of the transmitted radiation. In some embodiments, selected algae species 106 includes naturally occurring or modified strains of haematococcus, spirulina, chlorella, scenedesmus, chlamydomonas or the like. In some embodiments, selected algae species 106 is replaced with a different light-activated biological pathway such as yeast, flora, fauna, Araceae, bacteria, taxus, biota, or the like.

Specialty products 108 are by-products of cellular reactions within selected algae species 106. In some embodiments, specialty products 108 include starches, cannabinoids, ethanol, fuels, carotenoids, lipids, proteins, or other useful chemicals.

Biomass productivity varies for different light intensities in accordance with one or more embodiments. Light intensity is commonly quantified in terms of PFD (photon flux density), measured in μmol/m²·s. With excess nutrients in a growth medium for a light-activated biological pathway, PFD is a limiting reagent in production of useful chemicals, e.g., specialty produces 108 (FIG. 1). Biomass productivity of algae increases as light intensity increases.

For example, light-activated biological pathways which are exposed to high PFD exhibit an enhanced growth rate so long as photoinhibition from an over-abundance of light does not occur. Photoinhibition happens when an excess of photons damage protein D1 in photosystem II in chloroplasts of microalgal cells, for example. In addition, intense light exposure has been known to have negative effects on a variety of organisms including humans and animals. High PFD leads to an increase growth rate, but excess photons can damage cells, in some instances. Photons are able to be destructive to materials, molecules, and organisms at the molecular level by breaking bonds and activating undesired reactions such as rearrangements, oxidation, nitration, sulfonation, phosphorylation, displacements, and/or eliminations, and polymerization reactions.

In some embodiments, an optical filter, e.g., optical filter 104 (FIG. 1), is used to keep a sufficient but not inhibitory level of PFD incident on light-activated biological pathways. In some embodiments, a high light intensity is provided to the light-activated biological pathways for brief amounts of time (light/dark cycle) so that the light-activated biological pathways are able to benefit from the light and then recover from damage in the dark. In some embodiments, the optical filter is removable. In some embodiments, the optical filter is removable by retracting the optical filter. In some embodiments, the optical filter is able to be exchanged with another optical filter having different transmission characteristics. Other approaches include diluting high intensity light, which can be accomplished with opaque, neutral density filters, e.g., shade cloths, or by re-positioning photobioreactors. A drawback of the other approaches is that all wavelengths of light, even the beneficial wavelengths, are diluted.

Algal cellular activity varies with wavelength in accordance with one or more embodiments. Research in the field of photobioreactor design and photoinhibition generally measures PFD in terms of photons. Photosynthetic systems, though, use both light intensity received and also the wavelength of the radiation. For example, there are specific wavelengths which increase quantum efficiency as well as specific wavelengths which cause photoinhibition. Metabolic network reconstruction reveals a biological light-response phenomenon that helps to explain how photon absorption induces various metabolic pathways such as photosynthesis and vitamin synthesis. Natural sunlight covers all of the peak absorption wavelengths of light-activated biological In some embodiments, natural sunlight is the best source of light for all photoautotrophic organisms. Combinatorial light sources are able to be formed by using optical filters and multiple light sources to create a unique transmittance spectrum for targeted applications. In some embodiments, optical filters are applied to a surface area of the production system in varying ratios. For example, covering 10% of the surface area with a “blue filter” and a remaining surface area with a “red filter”. In some embodiments, an optical filter is applied on 50% or less of the production system surface area the remaining surface area will remain exposed to unfiltered light.

Cell growth resulting from different electromagnetic radiation sources varies in accordance with one or more embodiments. Cell growth performance is measurable under different targeted light sources such as laser or light emitting diodes (LEDs). For example, a laser technique is usable to generate a very narrow bandwidth of illumination and foresee potential applications of this narrow bandwidth illumination in hydrogen production from Chlamydamonas reinhardtii because of the ability of the laser technique to distinguish between activation wavelengths for PSI and PSII pathways.

LED testing reveals differences in algae growth under red, blue, and green lights. The different colors of light produced by LEDs affect growth, pigment composition, colony shape, and the rate of photosynthetic CO₂ uptake. One of ordinary skill in the art would recognize the LED testing would also be true for other photosynthetic organisms. The color differences between algae grown under white-light and algae grown under red-light are due to a change in carotenes and/or chlorophyll content, in some instances. Photobioreactors are equipped with red LEDs as the sole light source and demonstrate a cell growth difference between isolated red light and full spectrum light as well, where red light may be beneficial to growth, in some instances. Wavelength specific light are able to produce favorable results. The cell growth can increase with increasing PFD of the targeted light. Targeted light with a specific wavelength is beneficial for scale-up to commercial scale farming with solar irradiation, in some embodiments.

Commercial algae farms are dependent on the utilization of abundant solar light to drive algae photosynthesis for the production of valuable chemical outputs, in some instances. In general, high light intensity regions such as desert regions are favorable for algal growth. However, sub-optimal temperatures for algae growth increase photo-damage in algae cells. This means that due to high temperature fluctuation throughout the day, growth chambers in desert regions are susceptible to photo damage. Solar irradiance plays a large role in both temperature fluctuation and excess photons of damaging wavelengths, in some instances. In some embodiments, as opposed to using full spectra natural sunlight for algal growth, an optical filter, optical filter 104 (FIG. 1), provides a more moderate temperature fluctuation with little to no photo damage.

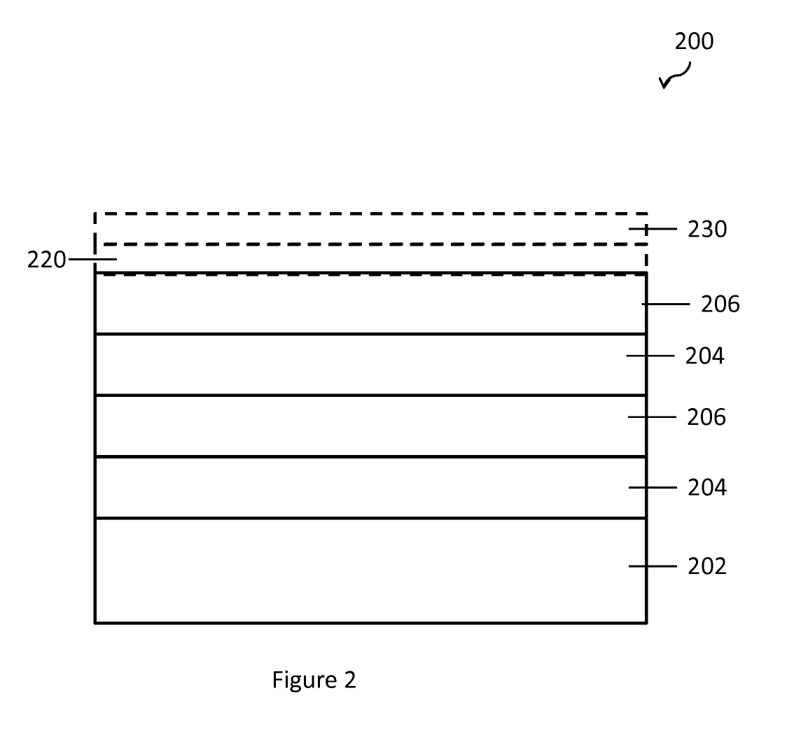

FIG. 2 is a cross sectional view of an optical filter 200 in accordance with one or more embodiments. Optical filter 200 includes a substrate 202. A first layer 204 having a first refractive index is over substrate 202. A second layer 206 having a second refractive index, different from the first refractive index, is over first layer 204. First layer 204 and second layer 206 are repeated in an alternating fashion over substrate 202. In some embodiments, optical filter 200 includes a protective layer 220 over a surface of second layer 206 distal from substrate 202. In some embodiments, optical filter 200 includes a self-cleaning layer 230. In some embodiments, self-cleaning layer 230 is on protective layer 220. In some embodiments, self-cleaning layer is on second layer 206 distal from substrate 202. In some embodiments, self-cleaning layer 230 is integrated with second layer 206 distal from substrate 202.

Embodiments of optical filters described herein include dichroic filters and a sub-type, the Fabry-Perot type filter. Fabry-Perot filters are based on thin film interference with two main structures. In some embodiments, the Fabry-Perot filter includes alternating layers of two materials with different refractive indices. The materials used, thickness, and refractive index of the layers can be dependent on what wavelength(s) intended to be transmitted by the filter. When light is incident on the filter, the internal reflections between the layers changes the phase of the incoming wavelengths. This phase change results in constructive/destructive interference. Depending on the thickness and number of layers, select wavelengths are reinforced. These reinforced wavelengths allow the filter to be tuned, for example, for a selected narrow pass band. The filter is also able to bee used to create multiple pass bands, broad or narrow. In some embodiments, a number of layers in optical filter 200 is eight or less.

Substrate 202 is used to provide mechanical support for first layer 204 and second layer 206. Substrate 202 is transparent with respect to a wavelength passed by first layer 202 and second layer 204. In some embodiments, substrate 202 is rigid. In some embodiments, substrate 202 is flexible. In some embodiments, the flexible substrate includes flexible glass, poly(ethylene naphthalate) (PEN), PTFE, PET, fluoropolymers, biaxially-oriented polyethylene terephthalate, or another suitable flexible material.

First layer 204 and second layer 206 are arranged in an alternating fashion over substrate 202. A thickness and a material of first layer 204 and of second layer 206 are selected to transmit a desired wavelength through optical filter 200. A number of alternating layers in optical filter 200 is adjusted to help define edges of a transmitted waveband of the optical filter, in some embodiments. In some embodiments, the number of alternating layers is four, i.e., two first layers 204 and two second layers 206. In some embodiments, the number of alternating layers is more or less than four. In some embodiments, first layer 204 and second layer 206 are independently selected from materials which include metal oxides, sulfides, nitrides, selenides, or oxynitrides. In some embodiments, first layer 204 and second layer 206 include materials which are extremely stable materials under conditions that are typically found in temperate regions. In some embodiments, first layer 204 and second layer 206 are free of metallic materials and organic materials. In some embodiments, first layer 204 and second layer 206 have a thickness sufficiently thin such that they can be mechanically stable enough for deposition onto flexible substrates. In some embodiments, a thickness of first layer 204 and a second layer 206 are independently selected to be approximately equal to a quarter of a wavelength of the wavelength transmitted by optical filter 200. In some embodiments, optical filter 200 is configured to transmit multiple wavelength peaks in the visible light spectrum. In some embodiments, optical filter 200 is configured to reflect non-transmitted wavelengths. In some embodiments, optical filter 200 is configured to avoid absorbing non-transmitted wavelengths.

In some embodiments, first layer 204 and second layer 206 include materials selected from Table 1 below. Mixtures and alloys of the materials are also suitable and give increased control over the physical, optical and electrical properties of the materials in optical filter 200, in some embodiments. Table 1 is representative but not an exhaustive list.

Protective layer 220 is used to prevent damage to optical filter 200. Protective layer 220 is transparent to a waveband transmitted by optical filter 200. In some embodiments, protective layer 220 includes a polymer material, such as PMMA, or another suitable protective material.

Self-cleaning layer 230 is used to prevent build up of contaminants on a surface of optical filter 200. Self-cleaning layer 230 is transparent to the waveband transmitted by optical filter 200. In some embodiments, self-cleaning layer 230 includes a same material as second layer 206. In some embodiments, self-cleaning layer 230 includes TiO₂. A thickness of self-cleaning layer is sufficiently low to avoid impacting optical properties of optical filter 200.

In some embodiments, first layer 204 and second layer 206 are not arranged in an alternating fashion. In some embodiments, optical filter 200 includes more than two different material layers.

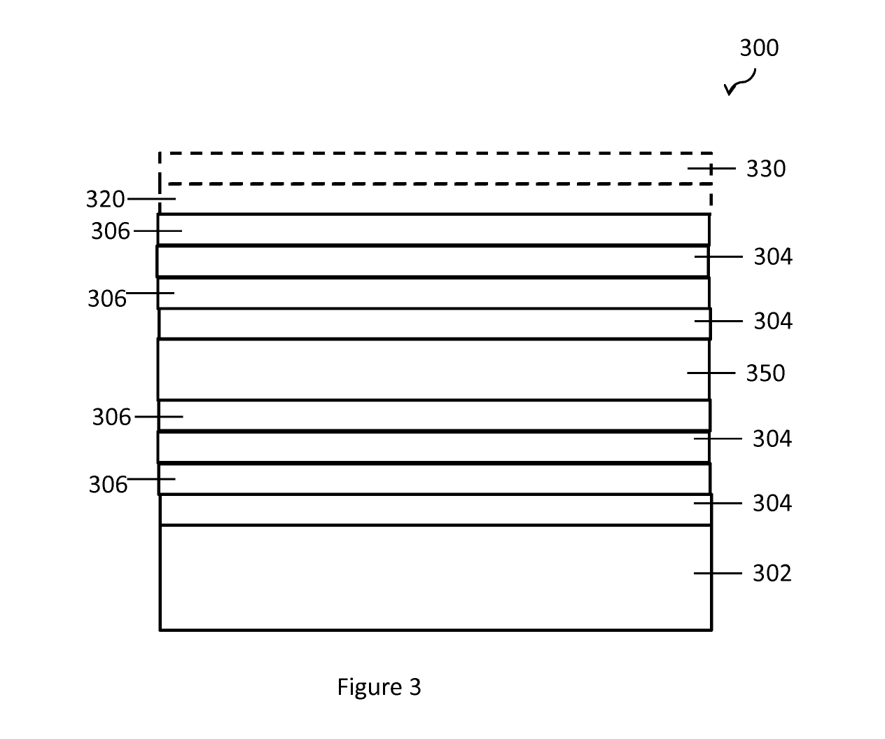

FIG. 3 is a cross sectional view of an optical filter 300 having a resonance cavity in accordance with one or more embodiments. Optical filter 300 is similar to optical filter 200. Similar reference elements have a same reference number increased by 100. Optical filter 300 differs from optical filter 200 in that optical filter 800 includes an etalon 350. Etalon 350 is a layer of a larger thickness than first layer 304 or second layer 306. Etalon 350 creates a resonant space to selectively reinforce a single wavelength with a small bandwidth. Optical filter 300 is usable, for example, to separate out the growth band or budding band to modify algae growth.

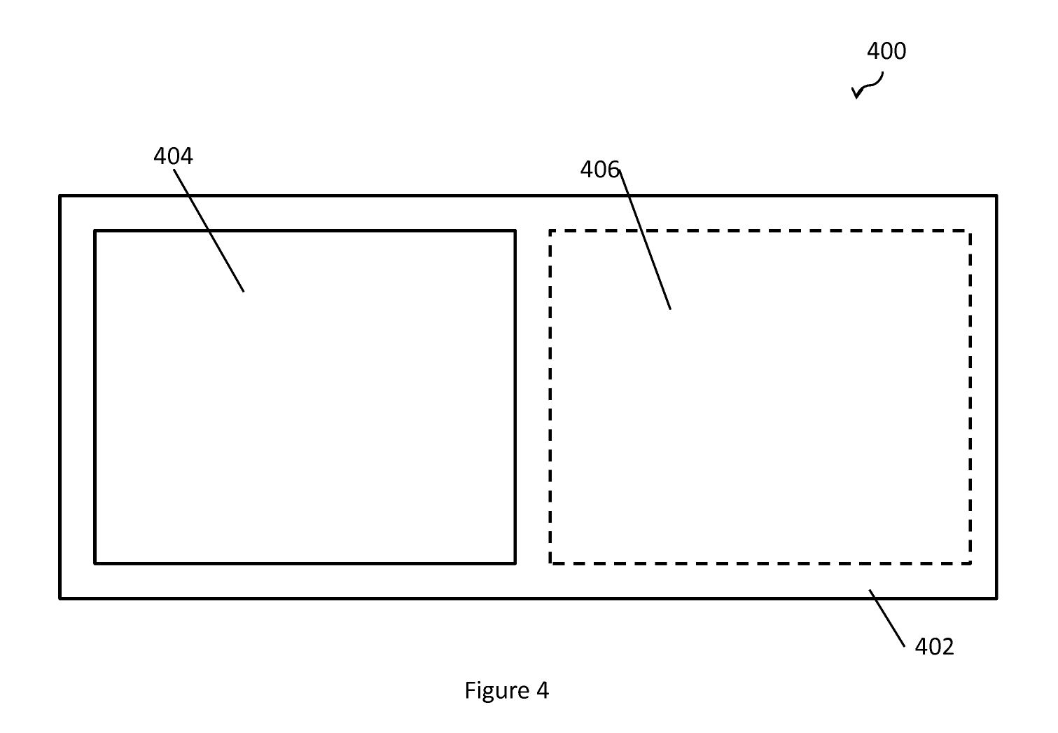

FIG. 4 is a top view of an optical filter 400 having a flexible substrate 402 in accordance with one or more embodiments. Optical filter 400 includes flexible substrate 402 on which a first filter 404 is formed. In some embodiments, a second filter 406 is also formed on flexible substrate 402. In some embodiments, first filter 404 or second filter 406 are similar to optical filter 200 or optical filter 800. In some embodiments, first filter 404 has a different pass-band from second filter 406. In some embodiments, one of first filter 404 or second filter 406 is a neutral density filter. In some embodiments, one of first filter 404 or second filter 406 reflects UV radiation and the other of the first filter or the second filter transmits UV radiation.

In some embodiments, multiple filters, e.g., optical filter 200, optical filter 800 or optical filter 400, are built on top of one another. In some embodiments including multiple filters, care is taken in the layer thicknesses to avoid disruption of intended pass-bands of the respective filters. In some embodiments, layer material and thickness are selected such that a filter allows the passing of wavebands centered around about 465 nm and about 680 nm. In some embodiments, a bandwidth of around 40 nm is sufficient to ensure proper penetration of the wavelengths into the light-activated biological pathways. In some embodiments, a wider band is used to obtain favorable results.

Versions of optical filters described herein have numerous advantages over other filters. In general, interference filters have better filtering characteristics than other filter methods. Optical filters described herein are advantageous due to the reflection of the unwanted wavebands. In a neutral density filter, where these wavelengths are absorbed, heat is maintained within a production system and the heat is dissipated by an additional cooling system to avoid damage to the filter. Since the pass band in an interference filter, e.g., optical filter 200 (FIG. 2) or optical filter 300 (FIG. 3), is based on interaction with the material and not absorption, the interference filter also helps to avoid photo-bleaching of the interference filter.

Any suitable method can be using for the development of optical filters in accordance with embodiments described herein. For example, methods to deposit the filter layers, e.g., first layer 204 and second layer 206, include Atomic Layer Deposition (ALD), Physical Vapor Deposition (PVD), and Chemical Vapor Deposition (CVD), electron beam, thermal evaporation, aerosol or wet chemical depositions. A plasma or voltage potential enhanced version of each method is also usable to obtain the desired properties. CVD, PVD, and e-beam are capable of a high deposition rate that is compatible with commercial deposition equipment. ALD is capable of extreme thickness control. Roll to roll or spatial ALD is a suitable process for commercial deposition of these filters. If band broadening resulting from moderate thickness control and uniformity is acceptable, PVD or CVD is usable to mass produce the filters on a flexible substrate. Any thin film deposition method that provides suitable control over thickness and refractive index could be used to deposit these materials. For applications requiring particularly tight pass bands, ALD provides a more controlled deposition. Roll-to-roll (flexible substrates) CVD, PVD, and ALD is also be utilized, in some embodiments. Nanolaminates are deposited using Atomic Layer Deposition (ALD) or Physical Vapor Deposition (PVD), in some embodiments.

### Example 1

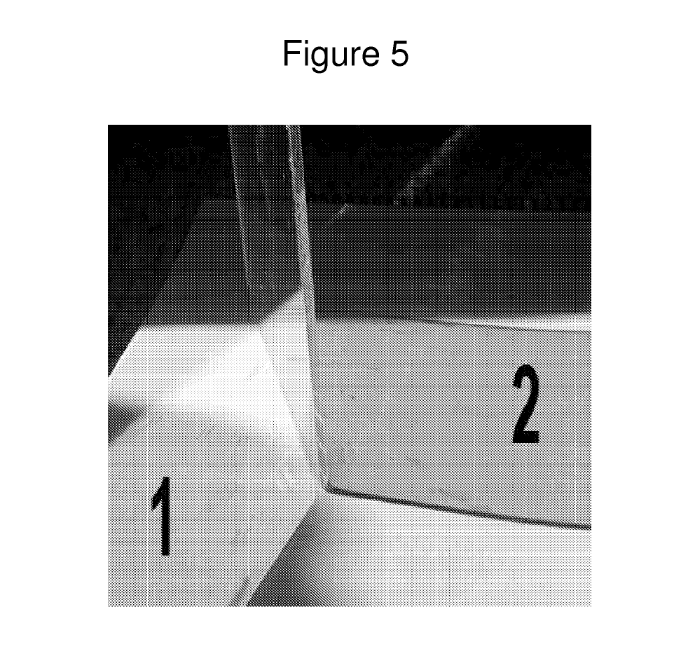

A thin-film optical filter can be created by depositing materials onto a rigid glass surface which measures 4″×4″. Visual inspection can confirm narrow band pass for red and blue wavelengths and high reflectivity of other wavelengths, as shown in FIG. 5. A control is an identical piece of glass without the deposited materials.

Thermal Testing of the Prototype Optical Filter:

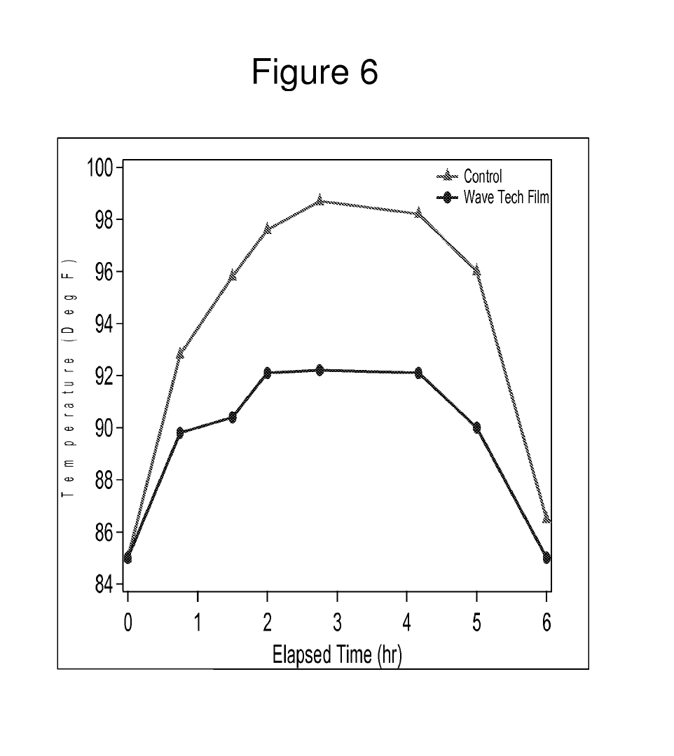

One potential advantage of an optical filter in accordance with embodiments describe herein is the ability to limit excess heat in a production system. Therefore, a test to evaluate the thermal insulation performance of a prototype optical filter was conducted under a high-sunlight environment. Two identical chambers, measuring 12″×12″×12″, were constructed from ¼″ plywood and coated with an insulative material which is also reflective (to limit heat from areas other than through the filter coated glass as well as retain heat which passed through the glass). One cube used the optical filter according to this description and the other cubed used the control. Temperature within each cube was measured every hour from noon until 6 pm. As shown in FIG. 6, the cube with the control had steadily maintained higher temperatures than the cube with the optical filter according to this description, indicating that a production system without a filtered coating according to this description runs at higher and potentially non-optimal temperatures, unless the production system is otherwise cooled.

Algal Culture Using the Thin-Film Base Optical Filter:

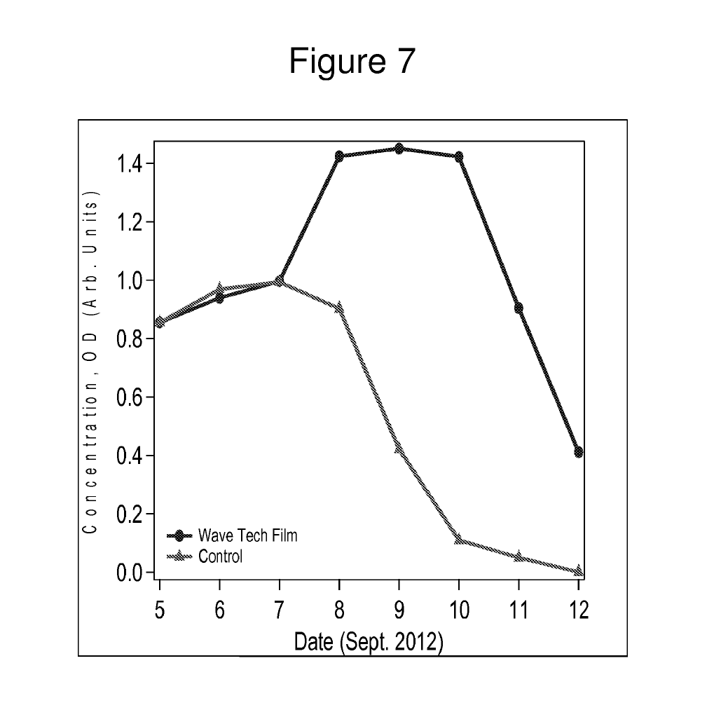

A preliminary experiment was performed to evaluate the algal growth using the two pieces of glass as described in the above section. For live culture experiments, two identical cube production systems were constructed with dimensions 4″×4″×4″. One reactor was covered with the optical filter based glass according to this description; the other reactor was covered with regular glass. The three remaining sides of each cube were constructed with acrylic material and covered by tape (to inhibit light penetration). The two chambers were placed on a shaker and under a high-pressure sodium lamp with a PFD of 400 μmol/m²·s. The alga Chlorella vulgaris were grown in axenic conditions with Bold's Basal Medium (BBM) being used. Room temperature was controlled at 22° C. As shown in FIG. 7, the culture covered with a thin-film optical filter resulted in a higher cell density than the control. The cell density is potentially due to effects of radiative heat generation in the control chamber which resulted in a poor growth. One of ordinary skill in the art would expect that the resulting difference between the regular production system and thin-film coated production system will be amplified given higher PFD conditions found in direct sunlight.

Thin-film optical filters according to this description are capable of reflecting unnecessary wavelengths of light, are cost-effective, are able to be implemented across multiple production system platforms, allow for high-volume applications, and help protect against UV degradation which helps to extend the life time of production system materials exposed to the UV irradiation.

### Example 2

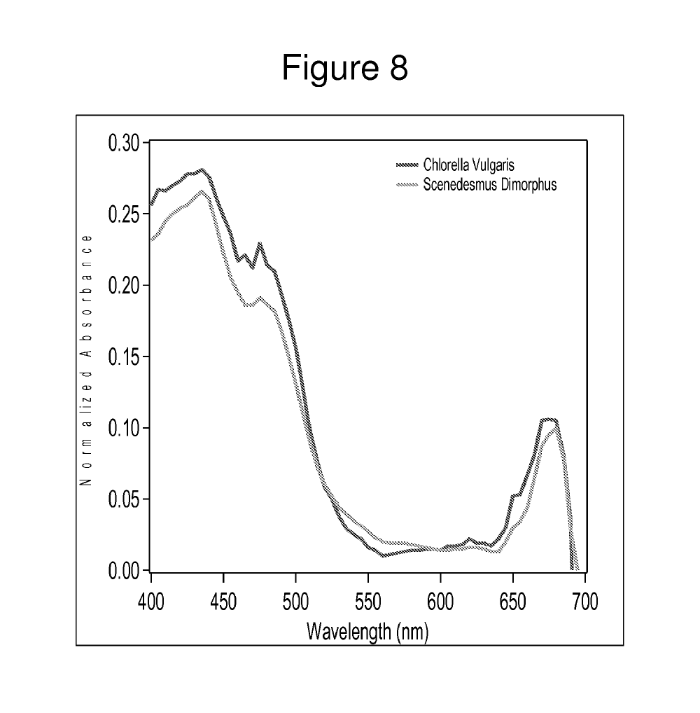

A first filter (Filter 1) was designed with a transmittance band in the red portion of the visible spectrum (centered at 685 nm). A second filter (Filter 2) was designed having two transmittance bands with one ranging from 435-490 and the other at 685 nm, which passes blue and red light, respectively. Filter 1 was used to test a sole band-pass wavelength in a deep red range for chlorophyll a targeting; in the case of algae growth, this light increases starch composition and impacts lipid composition. Filter 2 targets both chlorophyll b and carotenoids for algae growth (in the blue range) and energy production (through deep red spectra). This aligns with most green-algae. The wavelength(s) selected in the design of optical filters 1 and 2 correlate with experimental data on cell adsorption of Scenedesmus dimorphus and chlorella vulgaris in a preliminary test, the results of which are in FIG. 8.

An optical filter, i.e., Filter 1 and Filter 2, covered the front and rear surfaces of a large size flat panel production system (10′ long×4′ high×2.5″ wide) can be created. It will be appreciated that any suitable size, configuration, and dimensions are contemplated.

### Example 3

A nano-scale multi-layer optical filter on a rigid or flexible substrate, such as flexible glass, poly(ethylene naphthalate) (PEN), PTFE, PET, fluoropolymers, biaxially-oriented polyethylene terephthalate. An upper most layer of the filter included TiO2 and other layers contained TiO2 or Al2O3. An overcoat layer of organic or inorganic material was used to protect the filter from mechanical or chemical damage. The optical filter was used with natural or artificial light sources such that the filtered light can excite photosynthetic pathways of photoautotrohpic or heterotrophic organisms. These organisms were aquatic or terrestrial and may include algae, lemnoideae, cyanobacteria, taxus brevifolia, etc. These pathways included the PS1 and PS2 pathways as well as those pathways used to produce specialty chemicals. Versions of the filter reflected a portion or all of ultraviolet radiation (<400 nm) and infrared radiation (>700 nm). Versions of the filter transmitted one or more wavelengths of light in the photosynthetically active radiation (PAR) spectrum (400-700 nm) while minimizing the transmission of non-photosynthetically active radiation.

A non-limiting example of a filter can be a four layer filter comprising:

Substrate: BoPET;

First layer: Al2O3—50 nm;

Second layer: TiO2: 65 nm;

Third layer: Al2O3—50 nm;

Final/Fourth/Upper most filter layer: TiO2: 65 nm; and

Overcoat/Protective Layer/: 1-100 micronPMMA

For example, the filter transmitted spectra being two band-pass wavelengths with peaks at around 465 nm and around 680 or 685 nm. Bandwidths were around 10-80 nm wide.

Embodiments of the optical filter are created without emulsions or dyes and 2D patterning are not utilized. Embodiments of the filter are able to pass a narrow band and reflect wavelengths that are not photo-synthetically active. Embodiments of the filter minimize damage to biological organisms. Filters are manufactured using any thin film deposition technique with sufficient process control, in some embodiments. Embodiments provide film uniformity and low roughness. Embodiments of the filter are usable with special optics or shaped substrates to function. Embodiments of the filter are usable with widely available substrate materials, which maintain low costs. Embodiments pass photo-synthetically active radiation on non-specialized substrates. Embodiments of the optical filter include alternate inorganic layers or alternating inorganic dyads. Embodiments described herein are capable of utilizing certain materials, such as resin, chromophores. Wavelengths are reflected because of reflections at multiple interfaces, where certain versions can specify wavelength bands, in some embodiments. Embodiments described herein include a fluid filter or fresnel lens system, in some embodiments. Embodiments described herein include a dispersive or scattering component in the films, in some embodiments.

Embodiments described herein enable the use of abundant natural solar resources to achieve the desired wavelength or wavelengths of light for exciting photosynthetic pathways and help to eliminate the disadvantages of natural solar illumination such as overheating of reactors and or structures. In some embodiments, the optical filter is used with non-plant species such as filtering light to chicken coops for increased egg laying potential, altered light to enhance coral growth and/or health, rejecting light to inhibit the growth process of unwanted organisms or biofilms, rejecting light to reduce degradation of organic display materials, rejecting light to reduce the degradation of documents and artifacts, and rejecting light to reduce the degradation of beverages, medications, blood, biological plasma, fuels, lubricants, cleaning solutions, solvents, distillates, venoms, powders, or biological fluids. In some embodiments, the optical filter is used to limit harmful or undesirable radiation to human skin, eyes, or other organs.

Industrial algae growth generally requires a significant amount of electromagnetic radiation, temperature control, and is a high value agriculture product. Embodiments of optical filters described herein are a cost effective equipment modification for producers of any suitable flora, fauna, bacteria, biota, or the like that can benefit from targeted wavelengths or bands. For example, versions of the system can be used in markets such as high value terrestrial crops or vertically oriented production systems.

Embodiments described herein provide a longer lasting, self-cleaning, targeted light filter for current manufacturers using polymer bags, tents, or greenhouses. Open pond systems are able to reduce threats of contamination, introduction of competing organisms, reduce temperature variability, and avoid harmful radiation. A temporary or permanent structure with filter in temporary or permanent placement are used to alter the micro-climate. By using one or more optical filters described herein that are able to be selectively deployed or retracted the micro-climate can be further modified or controlled.

For production system applications, versions of a roll-on or stand alone product are used to provide the above benefits without compromising currently used materials. In some embodiments, films are produced for use as an after-market add-on which may be desirable for current producers. Such films are able to improve the lifespan of acrylic tanks by reducing the yellowing effect from ultraviolet rays.

For an application where a support structure is not readily available or feasible, the optical filter described herein are able to be modified to reflect the beneficial light onto plants from the ground. The optical filter is able to be tuned to reflect one or more portions of the desired bands of light. In some embodiments, the optical filter is deployed as reflective “mulch” having tunable reflectance spectra.

One aspect of this description relates to a production system including a structure configured to house a light-activated biological pathway. The production system further includes an optical filter attached to the structure. The optical filter is configured to receive light, to reflect a first portion of the received light, and to transmit a second portion of the received light, wherein the first portion has a different wavelength from the second portion. The production system is further configured to position the light-activated biological pathway to receive the second portion of the receive light.

Another aspect of this description relates to an optical filter includes a flexible substrate, and a first filter layer over the flexible substrate, wherein the first filter layer is free of metallic materials and organic materials. The optical filter further includes at least one second filter layer over the first filter layer, the second filter layer having a different refractive index from a refractive index of the first filter layer, wherein the second filter layer is free of metallic materials and organic materials. The optical filter is configured to transmit multiple peaks in the visible spectrum.

Still another aspect of this description relates to a method of using a production system. The method includes positioning an optical filter between a light source and a light-activated biological pathway, wherein the light-activated biological pathway is housed in the production system. The method further includes filtering light received from the light source using the optical filter. Filtering the light received from the light sources includes reflecting a first portion of the light received from the light source having a first waveband, and transmitting a second portion of the light received from the light source having a second waveband different from the first waveband. The method further includes producing a chemical output from the light-activated biological pathway by having the second portion of the light received from the light source be incident on the light-activated biological pathway.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto.

TABLE 1

| Name | Formula |
|---|---|
| Aluminum Oxide | Al₂O₃ |
| Beryllium Oxide | BeO |
| Cobalt (II) Oxide | CoO |
| Copper (I) Oxide | Cu₂O |
| Copper (II) Oxide | CuO |
| Gallium (III) Oxide | Ga₂O₃ |
| Gadolinium Oxide | Gd₂O₃ |
| Germanium Oxide | GeO₂ |
| Hafnium (IV) Oxide | HfO₂ |
| Indium (III) Oxide | In₂O₃ |
| Lutetium Oxide | Lu₂O₃ |
| Magnesium Oxide | MgO |
| Nickel (II) Oxide | NiO |
| Scandium Oxide | Sc₂O₃ |
| Silicon monoxide | SiO |
| Silicon dioxide | SiO₂ |
| Tantalum pentoxide | Ta₂O₅ |
| Tellurium dioxide | TeO₂ |
| Titanium (IV) Oxide | TiO₂ |
| Vanadium (V) oxide | V₂O₅ |
| Yttrium oxide | Y₂O₃ |
| Ytterbium oxide | Yb₂O₃ |
| Zinc (II) oxide | ZnO |
| Zirconium dioxide | ZrO₂ |
| Aluminum oxynitride | AlON |
| Silicon oxynitride | SiON |
| Boron phosphide | BaP |
| Gallium phosphide | GaP |
| Indium phosphide | InP |
| Zinc germanium diphosphide | ZnGeP₂ |
| Silver gallium selenide | AgGaSe₂ |
| Cadmium Selenide | CdSe |
| Lead Selenide | PbSe |
| Thallium arsenic selenide | Tl₃AsSe₃ |
| Zinc Selenide | ZnSe |
| Aluminum Nitride | AlN |
| Boron Nitride | BN |
| Indium Nitride | InN |
| Gallium Nitride | GaN |
| Silicon Nitride | Si₃N₄ |
| Titanium Nitride | TiN |
| Zirconium Nitride | ZrN |

What is claimed is:

1. A production system comprising:
a structure configured to house a light-activated biological pathway; and
an optical filter attached to the structure, the optical filter configured to receive light, to reflect a first portion of the received light, and to transmit a second portion of the received light, wherein the first portion has a different wavelength from the second portion,
wherein the production system is further configured to position the light-activated biological pathway to receive the second portion of the received light.

2. The production system of claim 1, wherein the first portion of the received light comprises infrared (IR) radiation and ultraviolet (UV) radiation.

3. The production system of claim 1, wherein the second portion of the received light comprises UV radiation.

4. The production system of claim 1, wherein the second portion of the received light comprises a waveband centered around about 685 nanometers (nm).

5. The production system of claim 1, wherein the second portion of the received light comprises light having a wavelength ranging from about 430 nm to about 490 nm.

6. The production system of claim 1, wherein the second portion of the received light comprises a first waveband having a wavelength ranging from about 430 nm to about 490 nm and a second waveband centered around about 685 nm, and the first portion of the received light comprises a third waveband between the first waveband and the second waveband.

7. The production system of claim 1, wherein the optical filter comprises a flexible substrate.

8. The production system of claim 1, wherein the optical filter comprises a self-cleaning layer.

9. The production system of claim 1, wherein the optical filter comprises a protective film.

10. The production system of claim 1, wherein the light-activated biological pathway comprises naturally occurring or modified micro algae, macro algae, yeast, flora, fauna, Araceae, bacteria, taxus, Nicotiana, fungi, Protista, Archaea, virus, or biota.

11. The production system of claim 1, further comprising a light source configured to emit the light received by the optical filter.

12. The production system of claim 11, wherein the light source comprises at least one of a light emitting diode (LED), a fluorescent light source, an incandescent light source, an arc lamp, lasers, or a high pressure sodium light.

13. The production system of claim 1, wherein the optical filter comprises a plurality of layers, wherein at least two layers of the plurality of layers have different refractive indices.

14. The production system of claim 13, wherein the optical filter further comprises an etalon.

15. The production system of claim 13, wherein the first layers comprise silicon dioxide and the second layer comprise titanium oxide, and a number of alternating layers is four.

16. An optical filter comprising:
a flexible substrate;
a first filter layer over the flexible substrate, wherein the first filter layer is free of metallic materials and organic materials; and
at least one second filter layer over the first filter layer, the second filter layer having a different refractive index from a refractive index of the first filter layer, wherein the second filter layer is free of metallic materials and organic materials, and the optical filter is configured to transmit multiple peaks in the visible spectrum.

17. The optical filter of claim 16, wherein the flexible substrate comprises flexible glass, poly(ethylene naphthalate) (PEN), biaxially-oriented polyethylene terephthalate (PET), PTFE, PET, or a fluoropolymer.

18. The optical filter of claim 16, further comprising a third filter layer over the at least one second filter layer, wherein the third filter layer has a different refractive index from the first filter layer and from the at least one second filter layer.

19. The optical filter of claim 16, further comprising a third filter layer over the at least one second filter layer, wherein the third filter layer has a same refractive index as the first filter layer or the at least one second filter layer.

20. The optical filter of claim 16, wherein the first filter layer comprises silicon dioxide and the second filter layer comprises titanium oxide.

21. The optical filter of claim 16, further comprising an etalon between the first filter layer and the at least one second filter layer.

22. The optical filter of claim 16, further comprising a self-cleaning layer over the at least one second filter layer.

23. The optical filter of claim 16, further comprising a protective layer over the at least one second filter layer.

24. A method of using a production system, the method comprises:
positioning an optical filter between a light source and a light-activated biological pathway, wherein the light-activated biological pathway is housed in the production system;
filtering light received from the light source using the optical filter, wherein filtering the light received from the light sources comprises:
reflecting a first portion of the light received from the light source having a first waveband, and
transmitting a second portion of the light received from the light source having a second waveband different from the first waveband; and
producing a chemical output from the light-activated biological pathway by having the second portion of the light received from the light source incident on the light-activated biological pathway.

25. The method of claim 24, wherein producing the chemical output comprises having the second portion of the light received form the light source be incident on the light-activated biological pathway comprising naturally occurring or modified micro algae, macro algae, yeast, flora, fauna, Araceae, bacteria, taxus, Nicotiana, fungi, Protista, Archaea, virus, or biota.

26. The method of claim 24, wherein transmitting the second portion of the light received from the light source comprises transmitting a waveband centered around about 685 nanometers (nm).

27. The method of claim 24, wherein transmitting the second portion of the light received from the light source comprises transmitting a wavelength ranging from about 430 nm to about 490 nm.

28. The method of claim 24, wherein transmitting the second portion of the light received from the light source comprises transmitting a first waveband having a wavelength ranging from about 430 nm to about 490 nm and a second waveband centered around about 685 nm, and reflecting the first portion of the light received from the light source comprises reflecting a third waveband between the first waveband and the second waveband.

29. The method of claim 24, wherein positioning the optical filter comprises positioning an optical filter comprising a flexible substrate.

30. The method of claim 24, further comprising emitting light from the light source, wherein the light source comprises at least one of a light emitting diode (LED), a fluorescent light source, an incandescent light source, an arc lamp, or a high pressure sodium light.
